(19) United States
(12) Patent Application Publication
(10) Pub. No.: US 2012/0132776 A1
(43) Pub. Date: May 31, 2012

(54) SUCTION DEVICE FOR ELECTRONIC COMPONENTS

(75) Inventor: PENG KUANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/177,974

(22) Filed: Jul. 7, 2011

(30) Foreign Application Priority Data
Nov. 29, 2010 (CN) 201010563894.7

(51) Int. Cl. F16B 47/00

(52) U.S. Cl. 248/363

(57) ABSTRACT

A suction device includes a suction cup, an operating member, a sealing member, an elastic member, and a stopping member. A gas hole is defined in the suction cup. A through hole is defined in the operating member, communicating with the gas hole. The suction cup is fixed to an end of the operating member. The sealing member includes a sealing portion to seal the gas hole, and a connection post connected to the sealing portion. A cross-sectional area of the connection post is smaller than that of the gas hole or the through hole. An end of the connection post extends through the gas hole and the through hole, and protrudes out from the operating member. The elastic member is sleeved on the connection post. The stopping member is fixed to the connection post. Opposite ends of the elastic member resist the operating member and the stopping member, respectively.

### BACKGROUND

1. Technical Field

The present disclosure relates generally to suction devices, especially, to a suction device for electronic components.

2. Description of Related Art

During an assembly process for workpieces with relatively high flatness or high cleanliness, such as touch screens or chips, a suction device is generally used to attach to and install the workpieces to avoid contaminating the workpieces. A suction device includes a vacuum generator, a gas source, a gas hose, a switch, and a suction cup. When the suction cup contacts a surface of the workpiece, air between the suction cup and the workpiece is drawn out by the vacuum generator controlled by the switch, so that the suction cup adheres to the workpiece by vacuum. When the workpiece needs to be detached from the suction cup, the gas source starts to increase the pressure between the workpiece and the suction cup. However, because the suction device includes a vacuum generator, a gas source, and a hose, the structure of the suction device is complicated, and much energy is consumed. Additionally, the hoses could get intertwined.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is an isometric view of a first embodiment of a suction device.

FIG. 2 is a cross-sectional view of the suction device of FIG. 1, taken along line II-II.

FIG. 3 is another cross-sectional view of the suction device of FIG. 1, taken along line III-III.

FIG. 4 is an isometric view of a second embodiment of a suction device.

FIG. 5 is a cross-sectional view of a third embodiment of a suction device.

FIG. 6 is a cross-sectional view of a fourth embodiment of a suction device.

### DETAILED DESCRIPTION

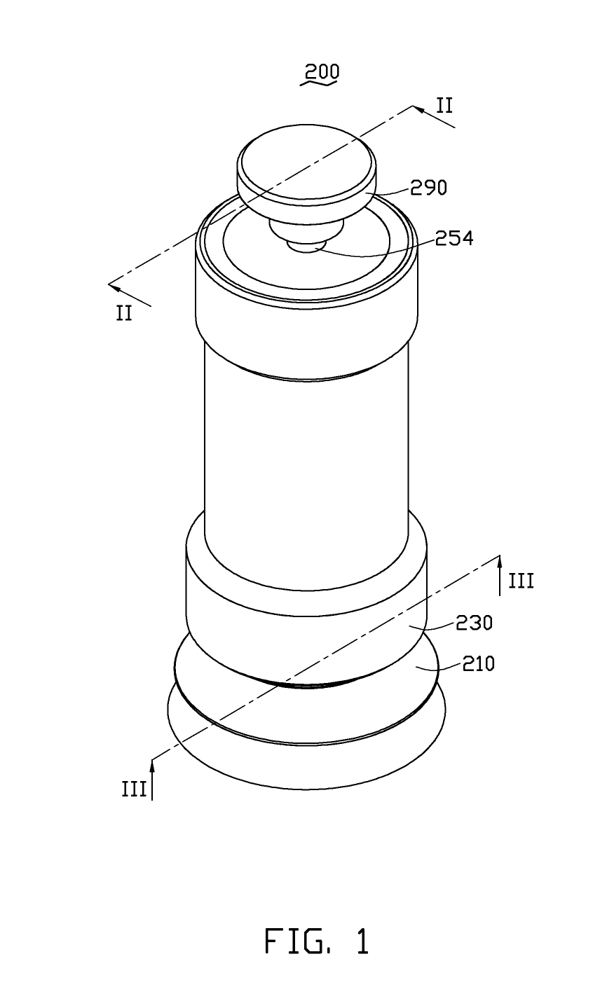

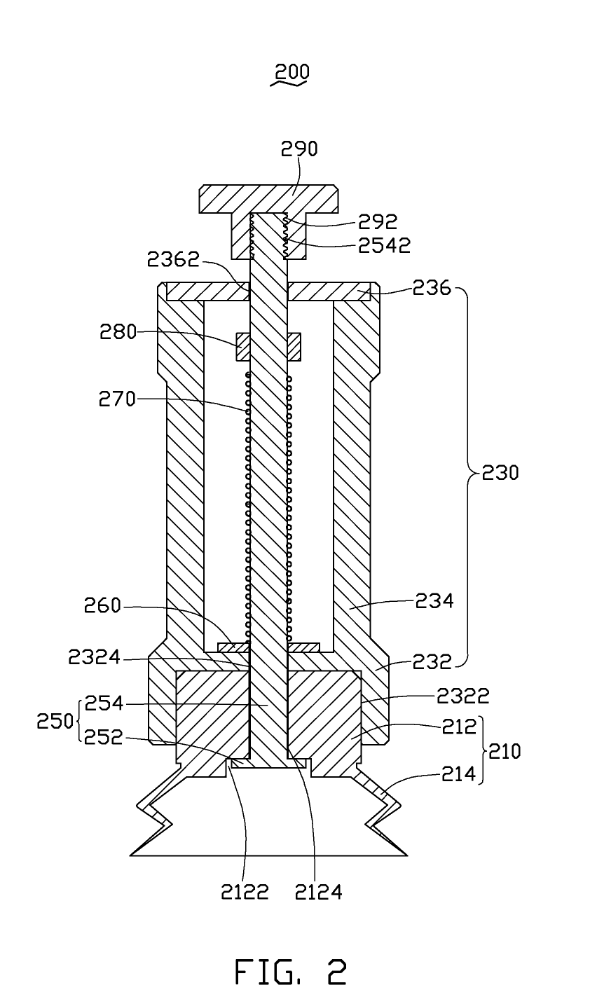

Referring to FIGS. 1 and 2, a first embodiment of a suction device 200 includes a suction cup 210, an operating member 230, a sealing member 250, a washer 260, an elastic member 270, a stopping member 280, and a pressing member 290. An end of the suction cup 210 is fixed to the operating member 230. The stopping member 280 is fixed to the sealing member 250. The elastic member 270 is sleeved on the sealing member 250 and resists the stopping member 280.

The suction cup 210 includes a base 212 and a plate portion 214 formed on the base 212. The base 212 is substantially cylindrical. A receiving recess 2122 is defined in an end of the base 212 adjacent to the plate portion 214. A gas hole 2124 is defined in a center of the base 212 along an axis, and communicates with the receiving recess 2122. The plate portion 214 is made of elastic materials, and forms a wrinkle shape, such that the plate portion 214 can be double-decked to increase the capacity and elasticity. It is noted that the plate portion 214 can be single-decked or multi-decked.

The operating member 230 includes a fixing portion 232, an operating portion 234, and an end cap 236. In the first embodiment, a receiving groove 2322 is defined in an end of the fixing portion 232. An end of the base 212 of the suction cup 210 is securely received in the receiving groove 2322 away from the plate portion 214. The receiving groove 2322 can be omitted, and an end of the base 212 is fixed to the fixing portion 232 by other methods, for example with adhesive. A through hole 2324 is defined in the fixing portion 232, corresponding to and communicating with the gas hole 2124. The operating portion 234 is substantially barrel-shaped, and extends from the fixing portion 232 away from the plate portion 214. The end cap 236 is placed on an end of the operating portion 234 away from the fixing portion 232, to cover the operating portion 234. A through hole 2362 is defined in the end cap 236. An axis of the two through holes 2362, 2324 are substantially collinear.

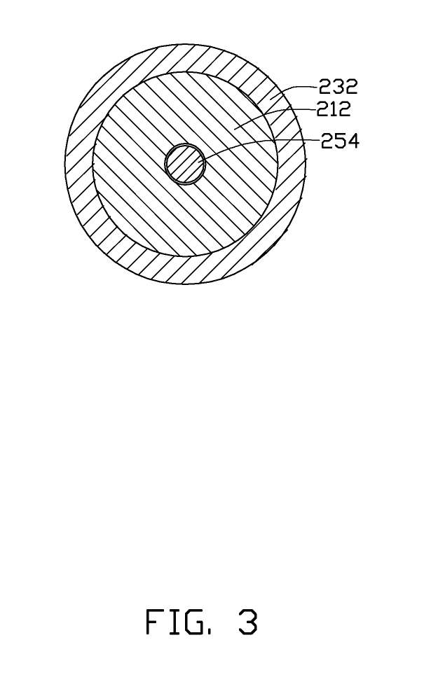

Referring also to FIG. 3, the sealing member 250 includes a sealing portion 252 and a connection post 254. The sealing portion 252 is substantially plate-like, and is received in the receiving recess 2122. A diameter of the sealing portion 252 is greater than that of the gas hole 2124. The connection post 254 extends upright from a center of the sealing portion 252. The connection post 254 is substantially cylindrical. A diameter of the connection post 254 is smaller than that of the gas hole 2124 or of the through hole 2324. An end of the connection post 254 extends through the gas hole 2124, and the through holes 2324, 2362 in that order, and protrudes out from the operating portion 234 away from the sealing portion 252. An end of the connection post 254 forms a threaded portion 2542 away from the sealing portion 252.

The washer 260 is received in the operating portion 234, and is sleeved on the connection post 254. A distance between the washer 260 and the connection post 254 is greater than zero. In the first embodiment, the elastic member 270 is a spring. The elastic member 270 is received in the operating portion 234, and is sleeved on the connection post 254. The elastic member 270 can be an elastic sleeve. The stopping member 280 is received in the operating portion 234, and is fixed to the connection post 254, such that opposite ends of the elastic member 270 resist the washer 260 and the stopping member 280, respectively. In the first embodiment, the stopping member 280 is a nut, and the connection post 254 forms another threaded portion (not shown) corresponding to the nut, thus the nut is engaged with the connection post 254.

A threaded hole 292 is defined in the pressing member 290, and is engaged with the threaded portion 2542 of the connection post 254. The pressing member 290 can be omitted, such that when using the suction device 200, the connection post 254 is directly pressed.

When sucking a workpiece, the operating member 230 is held to make the plate portion 214 contact the workpiece. The operating member 230 is pressed to exhaust air between the plate portion 214 and the workpiece, and the sealing member 250 seals the gas hole 2124 due to an action of the elastic member 270. Thus, a substantially vacuum environment is formed between the plate portion 214 and the workpiece, and the suction device 200 holds the workpiece. When releasing the workpiece, the pressing member 290 is pressed, and the elastic member 270 deforms from resistance by the stopping member 280. Thus, the sealing member 250 moves toward the workpiece, and external air enters into the plate portion 214 through the through hole 2324 and the gas hole 2124, thereby releasing the workpiece from the suction device 200.

Because the suction device 200 includes a sealing member 250 and defines a gas hole 2124, attaching to or releasing a workpiece is simple, and a gas source or a switch can be omitted. The suction device 200 has a simple structure, energy-efficient, and issues caused by intertwining hoses can be prevented.

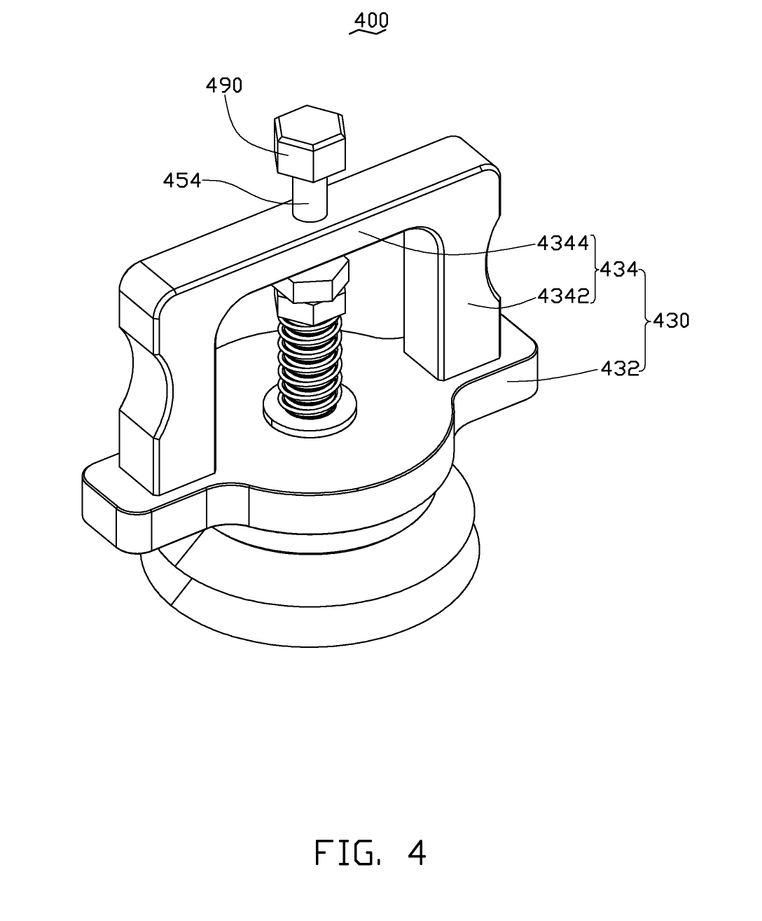

Referring to FIG. 4, a second embodiment of a suction device 400 has a similar structure to the first embodiment of the suction device 200. However, the operating portion 434 of the operating member 430 is substantially frame-like. The operating portion 434 includes two supporting posts 4342 and a rib 4344. The two supporting posts 4342 extend upright from two sides of the fixing portion 432, respectively. The rib 4344 is placed between and connects the two supporting posts 4342. A through hole (not shown) is defined in the rib 4344, such that the connection post 454 extends through the through hole. The pressing member 490 is a nut engaged with an end of the connection post 454. When a workpiece to be held is relatively heavy, the increased structural strength of the operation portion 434 can facilitate moving the suction device 400 and the workpiece together.

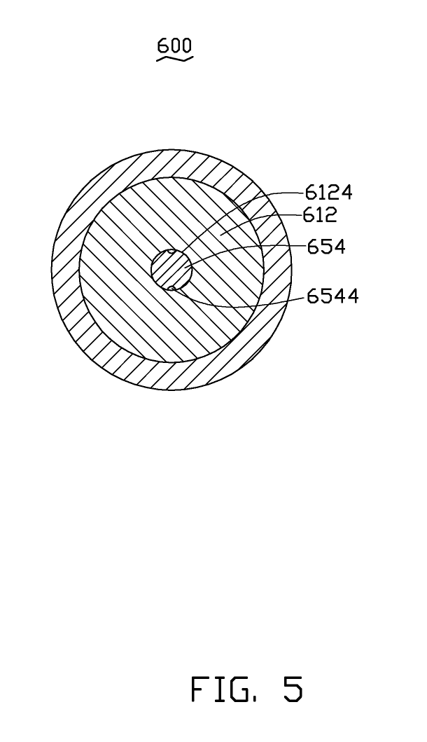

Referring to FIG. 5, a third embodiment of a suction device 600 has a similar structure to the first embodiment of the suction device 200. However, a diameter of the connection post 654 is substantially equal to that of the gas hole 6124 of the base 612 such that the connection post 654 may not be staggered. Two axial grooves 6544 are defined in the connection post 654 along the axis. Thus, a cross-sectional area of the connection post 654 is smaller than that of the gas hole 612, and when a workpiece is released, external air can enter into the plate portion through the axial grooves 6544. It is noted that the number of the axial grooves 6544 can be changed as needed.

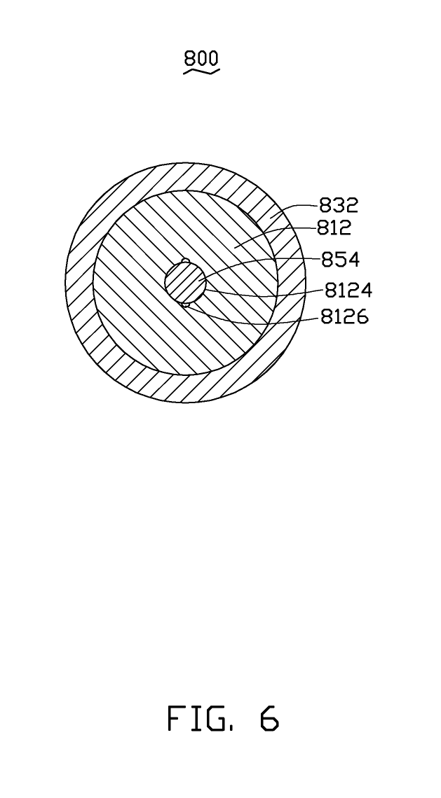

Referring to FIG. 6, a fourth embodiment of a suction device 800 has a similar structure to the first embodiment of the suction device 200. However, a diameter of the connection post 854 is substantially equal to that of the gas hole 8124 of the base 812 such that the connection post 854 cannot be staggered. Two axial grooves 8126 are defined in the sidewall of the gas hole 8124 along the axis, and two grooves (not shown) are defined in the sidewall defining the through hole (not shown) of the fixing portion 832, corresponding to the two axial grooves 8126, respectively. Thus, a cross-sectional area of the connection post 854 is smaller than that of the gas hole 8124 or the through hole of the fixing portion 832, and when releasing a workpiece, external air can enter into the plate portion through the axial grooves 8126. The number of the axial grooves 8126 can be changed as needed.

It is to be understood, however, that even through numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A suction device, comprising:
an operating member defining a through hole;
a suction cup fixed to an end of the operating member and defining a gas hole communicating with the through hole of the operating member;
a sealing member comprising a sealing portion to seal the gas hole, and a connection post connected to the sealing portion;
an elastic member sleeved on the connection post; and
a stopping member fixed to the connection post, wherein a cross-sectional area of the connection post is smaller than a cross-sectional area of the gas hole or the through hole, an end of the connection post extends through the gas hole and the through hole, and protrudes out from the operating member, and opposite ends of the elastic member resist the operating member and the stopping member, respectively.

2. The suction device of claim 1, wherein the operating member comprises a fixing portion and an operating portion, the suction cup is fixed to the fixing portion, the operating portion forms on an end of the fixing portion away from the suction cup.

3. The suction device of claim 2, wherein the suction cup comprises a base and a plate portion formed on an end of the base away from the operating portion, a receiving groove is defined in the fixing portion, and the base is received in the receiving groove.

4. The suction device of claim 3, wherein the plate portion forms a crimple shape, and is multi-decked.

5. The suction device of claim 1, wherein the connection post forms a threaded portion, and the stopping member comprises a nut engaged with the threaded portion.

6. The suction device of claim 1, further comprising a pressing member connected to an end of the connection post away from the sealing portion.

7. The suction device of claim 2, wherein the operating portion is substantially barrel shaped and extends from the end of the fixing portion away from the suction cup, and the elastic member and the stopping member are received in the operating portion.

8. The suction device of claim 2, wherein the operating portion comprises two supporting posts extending from two sides of the fixing portion, and a rib connecting the two supporting posts.

9. The suction device of claim 8, wherein a through hole is defined in the rib, and the connection post extends through the through hole of the rib.

10. The suction device of claim 1, wherein a diameter of the connection post is smaller than a diameter of the through hole or of the gas hole.

11. The suction device of claim 1, wherein a diameter of the connection post is substantially equal to a diameter of the through hole or of the gas hole, and an axial groove is defined in the connection post.

12. The suction device of claim 1, wherein a diameter of the connection post is substantially equal to a diameter of the through hole or of the gas hole, and axial grooves are defined in a sidewall defining the through hole and in a sidewall defining the gas hole.

13. A suction device, comprising:
a suction cup defining a gas hole;
an operating member defining a through hole communicating with the gas hole, and comprising a fixing portion and an operating portion;
a sealing member comprising a sealing portion to seal the gas hole, and a connection post connected to the sealing portion;
a stopping member fixed to the connection post;
an elastic member sleeved on the connection post and having opposite ends resisting the operating member and the stopping member, respectively; and
a pressing member connected to an end of the connection post away from the sealing portion, wherein the suction cup is fixed to the fixing portion, the operating portion forms on an end of the fixing portion away from the suction cup, a cross-sectional area of the connection post is smaller than a cross-sectional area of the gas hole or the through hole, and an end of the connection post extends through the gas hole and the through hole, and protrudes out from the operating member.

14. The suction device of claim 13, wherein the suction cup comprises a base and a plate portion formed on an end of the base away from the operating portion, a receiving groove is defined in the fixing portion, and the base is received in the receiving groove.

15. The suction device of claim 13, wherein the connection post forms a threaded portion, and the stopping member comprises a nut engaged with the threaded portion.

16. The suction device of claim 13, wherein the operating portion is substantially barrel shaped and extends from the end of the fixing portion away from the suction cup, and the elastic member and the stopping member are received in the operating portion.

17. The suction device of claim 13, wherein the operating portion comprises two supporting posts extending from two sides of the fixing portion, and a rib connecting the two supporting posts, a through hole is defined in the rib, and the connection post extends through the through hole of the rib.

18. The suction device of claim 13, wherein a diameter of the connection post is smaller than a diameter of the through hole or of the gas hole.

19. The suction device of claim 13, wherein a diameter of the connection post is substantially equal to a diameter of the through hole or of the gas hole, and an axial groove is defined in the connection post.

20. The suction device of claim 13, wherein a diameter of the connection post is substantially equal to a diameter of the through hole or of the gas hole, and axial grooves are defined in a sidewall defining the through hole and in a sidewall defining the gas hole.
